(19) United States
(12) Patent Application Publication
(10) Pub. No.: US 2003/0099258 A1
(43) Pub. Date: May 29, 2003

(54) Method for controlling pilot power of a cell within a CDMA system

(76) Inventors: George Calcev, Hoffman Estates, IL (US); Garry Hess, Elgin, IL (US)

Correspondence Address: MOTOROLA, INC., 1303 EAST ALGONQUIN ROAD, IL01/3RD, SCHAUMBURG, IL, 60196

(21) Appl. No.: 09/991,064

(22) Filed: Nov. 21, 2001

(51) Int. Cl. H04J 13/00; H04B 3/10

(52) U.S. Cl. 370/479; 370/491

(57) ABSTRACT

The invention provides a method for controlling pilot power within a CDMA system by either conditionally increasing or conditionally decreasing the pilot power of a cell when a transcoder loss per frame of the cell exceeds a threshold value. A cell performance matrix of the cell, and a cluster performance matrix of a cell cluster neighboring the cell are computed when a transcoder loss per frame of the cell exceeds the threshold value. The pilot power is increased when both the cell performance matrix is equal to or greater than the cluster performance matrix and the pilot power is greater than a minimum level. The pilot power is decreased when both the cell performance matrix is less than the cluster performance matrix and the pilot power is less than a maximum level.

### FIELD OF THE INVENTION

The present invention generally relates to the field of communication systems. More specifically, the invention relates to a control of pilot power within a Code-Division Multiple Access (CDMA) system.

### BACKGROUND OF THE INVENTION

Code-Division Multiple Access (CDMA) is a well-known spread-spectrum physical layer technology for cellular systems. Performance in a CDMA network is strongly affected by the traffic load and the user distribution per cell within the CDMA network. Typically, the pilot powers of each cell within the CDMA network are designed based upon expected traffic loads and measured fading conditions in the field. The pilot powers are then kept constant irrespective of any significant variance in traffic loads and/or fading conditions over time. The result can be a substandard performance of the CDMA network in terms of call drops during significant variations in traffic loads and/or fading condition.

Therefore, it would be desirable to have an adaptive pilot power control to improve the performance of the CDMA network under actual conditions.

### SUMMARY OF THE INVENTION

One form of the invention is a method for controlling a pilot power of a cell within a CDMA network. First, a transcoder loss per frame within the cell is determined. Second, a cell performance matrix of the cell is computed when the transcoder loss per frame is equal to or greater than a threshold value. The pilot power is controlled as a function of the cell performance matrix.

A second form of the invention is a CDMA network comprising a cell and a base station. The base station is operable to determine a transcoder loss per frame within the cell. The base station is further operable to compute a cell performance matrix of the cell when the transcoder loss per frame is equal to or greater than a threshold value.

A third form of the invention is a CDMA network comprising a cell, means for determining a transcoder loss per frame within the cell, and means for computing a cell performance matrix of the cell when the transcoder loss per frame is equal to or greater than a threshold value.

A fourth form of the present invention is a computer readable medium storing a computer program for controlling a pilot power of a cell within a CDMA network. The computer readable medium comprises means for determining a transcoder loss per frame within the cell, and computer readable code for computing a cell performance matrix of the cell when the transcoder loss per frame is equal to or greater than a threshold value.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an overview diagram of one embodiment of a cellular pattern of a CDMA network in accordance with the present invention;

FIG. 2 is a block diagram illustrating one embodiment of a home cell of the CDMA network of FIG. 1 in accordance with the present invention; and

FIG. 3 is a flowchart illustrating one embodiment of a method for controlling pilot power within the CDMA network of FIG. 1 in accordance with the present invention.

### DETAILED DESCRIPTION OF THE PRESENTLY PREFERRED EMBODIMENTS

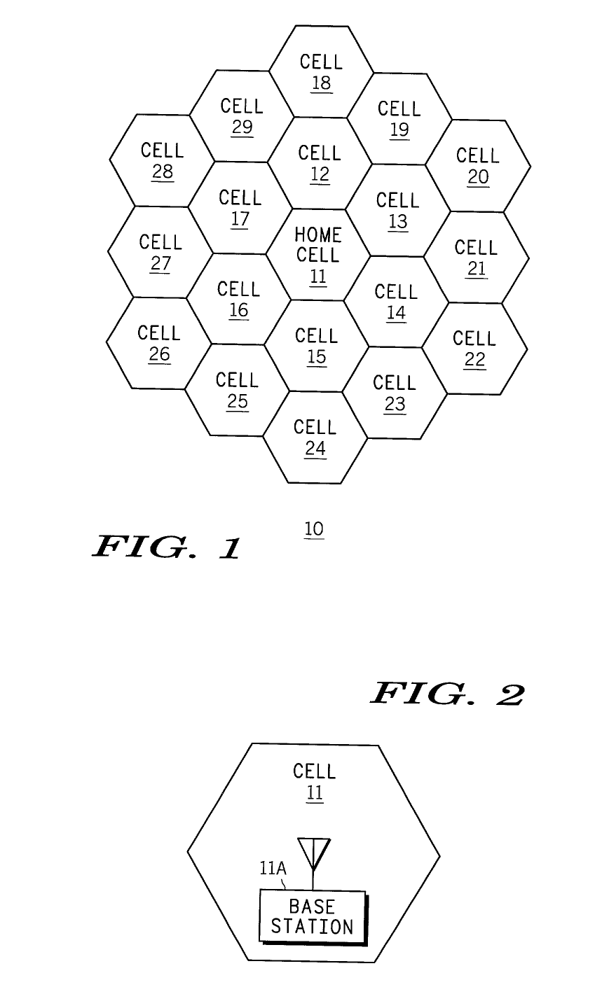

FIG. 1 illustrates a cellular pattern of a CDMA network 10 in accordance with one embodiment of the present invention. The cellular pattern includes a plurality of cells 11-29. Each cell 11-29 has neighboring cells forming a cell cluster. The following TABLE 1 lists each cell and its corresponding cell cluster:

TABLE 1

| CELL | CELL CLUSTER |
|---|---|
| 11 | 12-17 |
| 12 | 11, 13, 17-19, 29 |
| 13 | 11, 12, 14, 19-21 |
| 14 | 11, 13, 15, 21-23 |
| 15 | 11, 14, 16, 23-25 |
| 16 | 11, 15, 17, 25-27 |
| 17 | 11, 12, 16, 27-29 |
| 18 | 12, 19, 29 |
| 19 | 12, 13, 18, 20 |
| 20 | 13, 19, 21 |
| 21 | 13, 14, 20, 22 |
| 22 | 14, 21, 23 |
| 23 | 14, 15, 22, 24 |
| 24 | 15, 23, 25 |
| 25 | 15, 16, 24, 26 |
| 26 | 16, 25, 27 |
| 27 | 16, 17, 26, 28 |
| 28 | 17, 27, 29 |
| 29 | 12, 17, 18, 28 |

Each cell 11-29 includes a base station (not shown) having conventional hardware and software for providing communication service within the corresponding cell. A description of the conventional hardware and software is not provided herein. However, those having ordinary skill in the art will appreciate various conventional methods and devices implemented by the base stations to measure a cell power, a traffic, a frame erasure, a plurality of frames, a transcoder loss per frame, a transcoder loss uplink, a transcoder loss downlink, and an average energy per chip per interference density measured on the pilot channel associated with the corresponding cell.

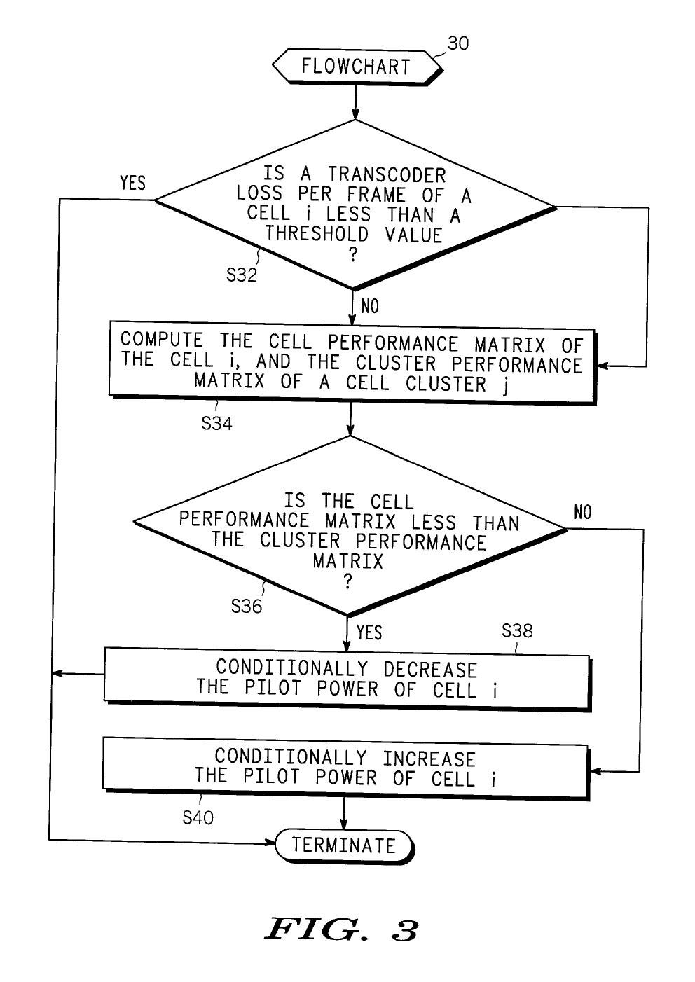

FIG. 2 illustrates the home cell 11 in accordance with one embodiment of the present invention. The home cell 11 includes a base station 11a. In addition to the aforementioned conventional hardware and software, the base station 11a includes hardware, software or a combination of hardware and software for controlling a pilot power of each cell 11-29 within the CDMA network 10 in accordance with the present invention. FIG. 3 illustrates a flowchart 30 that is representative of a method for controlling a pilot power of each cell 11-29 within the CDMA network 10 that is implemented by the base station 11a. In one embodiment, the base station 11a executes the flowchart 30 for each cell 11-29 over a fixed time interval (e.g., every 8 seconds). The flowchart 30 will now be described herein in the context of an execution of the flowchart 30 for the home cell 11.

During a stage S32 of the flowchart 30, the base station 11a determines if a transcoder loss per frame of the home cell 11 is less than a threshold value established by actual operational parameters of the CDMA network 10 as would be appreciated by those having ordinary skill in the art. If the base station 11a determines the transcoder loss per frame of the home cell 11 is less than the threshold value, the base station 11a proceeds to terminate the flowchart 30. As a result, the pilot power of the home cell 11 remains constant.

If the base station 11a determines the transcoder loss per frame of the home cell 11 is equal to or greater than the threshold value, the base station 11a proceeds to a stage S34 of the flowchart 30 to compute a cell performance metric for the home cell 11 and a cluster performance matrix for the cell cluster associated with the home cell 11. In one embodiment, the cell performance metric of the cell 11 is computed in accordance with the following equation [1]:

$$\begin{matrix}{CellPerformanceMetric}_{11} = ( \frac{{CP}_{11}}{{T}_{11}} ) \times ( \frac{{FE}_{11}}{{F}_{11}} ) \times ( \frac{{TLU}_{11}}{{TLD}_{11}} ) \times \\ ( \frac{Ec}{Io} {Average}_{11} )\end{matrix} \qquad [ 1 ]$$

In equation [1], CP₁₁ is a measured cell power of the home cell 11, T₁₁ is a measured traffic of the home cell 11, FE₁₁ is a measured frame erasure of the home cell 11, F₁₁ is a measured number of frames of the home cell 11, TLU₁₁ is a measured transcoder loss uplink of the home cell 11, TLD₁₁ is a measured transcoder loss downlink of the home cell 11, and Ec/lo Average₁₁ is measured energy per chip per interference density measured on the pilot channel of the home cell 11. The Ec/lo Average₁₁ can be based upon a Pilot Strength Measurement Message and a Power Measurement Report Message received from each communication device (e.g., a mobile phone) attached to the home cell 11.

The cluster performance matrix is an average of a computation of each cell performance matrix of each cell within the cluster. Thus, the base station 11a would communicate with the base stations of the cell cluster 12-17 to obtain the necessary measured parameters for the following equations [2]-[7]:

$$\begin{matrix}{CellPerformanceMetric}_{12} = ( \frac{{CP}_{12}}{{T}_{12}} ) \times ( \frac{{FE}_{12}}{{F}_{12}} ) \times ( \frac{{TLU}_{12}}{{TLD}_{12}} ) \times \\ ( \frac{Ec}{Io} {Average}_{12} )\end{matrix} \qquad [ 2 ]$$

In equation [2], CP₁₂ is a measured cell power of the home cell 12, T₁₂ is a measured traffic of the home cell 12, FE₁₂ is a measured frame erasure of the home cell 12, F₁₂ is a measured number of frames of the home cell 12, TLU₁₂ is a measured transcoder loss uplink of the home cell 12, TLD₁₂ is a measured transcoder loss downlink of the home cell 12, and Ec/lo Average₁₂ is measured energy per chip per interference density measured on the pilot channel of the home cell 12. The Ec/lo Average₁₂ can be based upon a Pilot Strength Measurement Message and a Power Measurement Report Message received from each communication device (e.g., a mobile phone) attached to the home cell 12.

$$\begin{matrix}{CellPerformanceMetric}_{13} = ( \frac{{CP}_{13}}{{T}_{13}} ) \times ( \frac{{FE}_{13}}{{F}_{13}} ) \times ( \frac{{TLU}_{13}}{{TLD}_{13}} ) \times \\ ( \frac{Ec}{Io} {Average}_{13} )\end{matrix} \qquad [ 3 ]$$

In equation [3], CP₁₃ is a measured cell power of the home cell 13, T₁₃ is a measured traffic of the home cell 13, FE₁₃ is a measured frame erasure of the home cell 13, F₁₃ is a measured number of frames of the home cell 13, TLU₁₃ is a measured transcoder loss uplink of the home cell 13, TLD₁₃ is a measured transcoder loss downlink of the home cell 13, and Ec/lo Average₁₃ is measured energy per chip per interference density measured on the pilot channel of the home cell 13. The Ec/lo Average₁₃ can be based upon a Pilot Strength Measurement Message and a Power Measurement Report Message received from each communication device (e.g., a mobile phone) attached to the home cell 13.

$$\begin{matrix}{CellPerformanceMetric}_{14} = ( \frac{{CP}_{14}}{{T}_{14}} ) \times ( \frac{{FE}_{14}}{{F}_{14}} ) \times ( \frac{{TLU}_{14}}{{TLD}_{14}} ) \times \\ ( \frac{Ec}{Io} {Average}_{14} )\end{matrix} \qquad [ 4 ]$$

In equation [4], CP₁₄ is a measured cell power of the home cell 14, T₁₄ is a measured traffic of the home cell 14, FE₁₄ is a measured frame erasure of the home cell 14, F₁₄ is a measured number of frames of the home cell 14, TLU₁₄ is a measured transcoder loss uplink of the home cell 14, TLD₁₄ is a measured transcoder loss downlink of the home cell 14, and Ec/lo Average₁₄ is measured energy per chip per interference density measured on the pilot channel of the home cell 14. The Ec/lo Average₁₄ can be based upon a Pilot Strength Measurement Message and a Power Measurement Report Message received from each communication device (e.g., a mobile phone) attached to the home cell 14.

$$\begin{matrix}{CellPerformanceMetric}_{15} = ( \frac{{CP}_{15}}{{T}_{15}} ) \times ( \frac{{FE}_{15}}{{F}_{15}} ) \times ( \frac{{TLU}_{15}}{{TLD}_{15}} ) \times \\ ( \frac{Ec}{Io} {Average}_{15} )\end{matrix} \qquad [ 5 ]$$

In equation [5], CP₁₅ is a measured cell power of the home cell 15, T₁₅ is a measured traffic of the home cell 15, FE₁₅ is a measured frame erasure of the home cell 15, F₁₅ is a measured number of frames of the home cell 15, TLU₁₅ is a measured transcoder loss uplink of the home cell 15, TLD₁₅ is a measured transcoder loss downlink of the home cell 15, and Ec/lo Average₁₅ is measured energy per chip per interference density measured on the pilot channel of the home cell 15. The Ec/lo Average₁₅ can be based upon a Pilot Strength Measurement Message and a Power Measurement Report Message received from each communication device (e.g., a mobile phone) attached to the home cell 15.

$$\begin{matrix}{CellPerformanceMetric}_{16} = ( \frac{{CP}_{16}}{{T}_{16}} ) \times ( \frac{{FE}_{16}}{{F}_{16}} ) \times ( \frac{{TLU}_{16}}{{TLD}_{16}} ) \times \\ ( \frac{Ec}{Io} {Average}_{16} )\end{matrix} \qquad [ 6 ]$$

In equation [6], CP₁₆ is a measured cell power of the home cell 16, T₁₆ is a measured traffic of the home cell 16, FE₁₆ is a measured frame erasure of the home cell 16, F₁₆ is a measured number of frames of the home cell 16, TLU₁₆ is a measured transcoder loss uplink of the home cell 16, TLD₁₆ is a measured transcoder loss downlink of the home cell 16, and Ec/lo Average₁₆ is measured energy per chip per interference density measured on the pilot channel of the home cell 16. The Ec/lo Average₁₆ can be based upon a Pilot Strength Measurement Message and a Power Measurement Report Message received from each communication device (e.g., a mobile phone) attached to the home cell 16.

$$\begin{matrix}{CellPerformanceMetric}_{17} = ( \frac{{CP}_{17}}{{T}_{17}} ) \times ( \frac{{FE}_{17}}{{F}_{17}} ) \times ( \frac{{TLU}_{17}}{{TLD}_{17}} ) \times \\ ( \frac{Ec}{Io} {Average}_{17} )\end{matrix} \qquad [ 7 ]$$

In equation [7], CP₁₇ is a measured cell power of the home cell 17, T₁₇ is a measured traffic of the home cell 17, FE₁₇ is a measured frame erasure of the home cell 17, F₁₇ is a measured number of frames of the home cell 17, TLU₁₇ is a measured transcoder loss uplink of the home cell 17, TLD₁₇ is a measured transcoder loss downlink of the home cell 17, and Ec/lo Average₁₇ is measured energy per chip per interference density measured on the pilot channel of the home cell 17. The Ec/lo Average₁₇ can be based upon a Pilot Strength Measurement Message and a Power Measurement Report Message received from each communication device (e.g., a mobile phone) attached to the home cell 17.

Upon receipt of the aforementioned parameters, the base station 11a computes a cell performance matrix for each cell 12-17, and then averages the computed cell performance matrixes to obtain the cluster performance matrix.

Upon computing the cell performance matrix of the cell 11 and the cluster performance matrix of the cell cluster 12-17, the base station 11a proceeds to a stage S36 of the flowchart 30 to determine if the cell performance matrix is less than the cluster performance matrix. When the base station 11a determines the cell performance matrix is less than the cluster performance matrix, the base station 11a proceeds to a stage S38 of the flowchart 30 to conditionally decrease the pilot power of the home cell 11. Otherwise, the base station 11a proceeds to a stage S40 of the flowchart 30 to conditionally increase the pilot power of the home cell 11.

In one embodiment, the home cell 11 is designed with a minimum level and a maximum level for the pilot power of the home cell 11 that are established by actual operational parameters of the CDMA network 10 as would be appreciated by those having ordinary skill in the art. During stage S38 of the flowchart 30, the following condition [8] must be satisfied before the pilot power of the home cell 11 is decreased:

PP_{CURRENT}−X≧PP_{MINIMUM} [8]

In condition [8], PP_{CURRENT} is the current level of the pilot power of the home cell 11, X is a number that is either a fixed decrement, a variable decrement, or a decrement equal to a percentage of the current level of the pilot power PP_{CURRENT}, and PP_{MINIMUM} is the minimum level established for the pilot power of the home cell 11. When the condition [8] is satisfied, the current level of the pilot power PP_{CURRENT} is decreased by X.

During stage S40 of the flowchart 30, the following condition [9] must be satisfied before the pilot power of the home cell 11 is decreased:

PP_{CURRENT}+Y≦PP_{MAXIMUM} [9]

In condition [9], PP_{CURRENT} is again the current level of the pilot power of the home cell 11, Y is a number that is either a fixed increment, a variable increment, or an increment equal to a percentage of the current level of the pilot power PP_{CURRENT}, and PP_{MAXIMUM} is the maximum level established for the pilot power of the home cell 11. When the condition [9] is satisfied, the current level of the pilot power PP_{CURRENT} is increased by Y.

The base station 11a terminates the flowchart 30 upon completion of either stage S38 or stage S40. From the preceding description herein of the flowchart 30, those having ordinary skill in the art will appreciate the execution of the flowchart 30 for cells 12-29 and associated cell clusters.

The flowchart 30 was described herein in the context of the home cell 11 executing the flowchart 30 for each cell 12-29. In alternative embodiments, each cell 12-29 can individually execute the flowchart 30, one or more cells with the CDMA network 10 can execute the flowchart 30 for different groupings of cells therein. Stage S32 may be omitted in alternate embodiments of the flowchart 30.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In a CDMA network, a method for controlling a pilot power of a cell, said method comprising:
determining a transcoder loss per frame within the cell; and
computing a cell performance matrix of the cell when the transcoder loss per frame is equal to or greater than a threshold value.

2. The method of claim 1, wherein the cell performance matrix is computed according to:
$$\begin{matrix}CellPerformanceMetric = ( \frac{CP}{T} ) \times ( \frac{FE}{F} ) \times ( \frac{TLU}{TLD} ) \times \\ ( \frac{Ec}{Io} Average )\end{matrix}$$

3. The method of claim 1, further comprising:
computing a cluster performance matrix of a cell cluster associated with the cell when the transcoder loss per frame is equal to or greater than a threshold value, the cell cluster.

4. The method of claim 3, wherein the cluster performance matrix is an average of each cell performance matrix for each cell within the cell cluster, and each cell performance matrix is computed according to:
$$\begin{matrix}CellPerformanceMetric = ( \frac{CP}{T} ) \times ( \frac{FE}{F} ) \times ( \frac{TLU}{TLD} ) \times \\ ( \frac{Ec}{Io} Average )\end{matrix}$$

5. The method of claim 3, further comprising:
conditionally decreasing the pilot power of the cell when the cell performance matrix is less than the cluster performance matrix.

6. The method of claim 3, further comprising:
conditionally increasing the pilot power of the cell when the cell performance matrix is equal to or greater than the cluster performance matrix.

7. A CDMA network, said comprising:
a cell having a pilot power; and
a base station operable to determine a transcoder loss per frame within said cell, and to compute a cell performance matrix of said cell when the transcoder loss per frame is equal to or greater than a threshold value.

8. The CDMA network of claim 7, wherein said base station computes the cell performance matrix according to:
$$\begin{matrix}CellPerformanceMetric = ( \frac{CP}{T} ) \times ( \frac{FE}{F} ) \times ( \frac{TLU}{TLD} ) \times \\ ( \frac{Ec}{Io} Average )\end{matrix}$$

9. The CDMA network of claim 7, further comprising:
a cell cluster associated with said cell,
wherein said base station is further operable to compute a cluster performance matrix of said cell cluster when the transcoder loss per frame is equal to or greater than a threshold value.

10. The CDMA network of claim 9, wherein said base station computes the cluster performance matrix as an average of each cell performance matrix for each cell within the cell cluster, and computes each cell performance matrix according to:
$$CellPerformanceMetric = ( \frac{CP}{T} ) \times ( \frac{FE}{F} ) \times ( \frac{TLU}{TLD} ) \times ( \frac{Ec}{Io} Average )$$

11. The CDMA network of claim 9, wherein said base station is further operable to conditionally decrease the pilot power of said cell when the cell performance matrix is less than the cluster performance matrix.

12. The CDMA network of claim 9, wherein said base station is further operable to conditionally increase the pilot power of said cell of the cell when the cell performance matrix is equal to or greater than the cluster performance matrix.

13. A CDMA network, comprising:
a cell having a pilot power;
means for determining a transcoder loss per frame within a cell; and
means for computing a cell performance matrix of the cell when the transcoder loss per frame is equal to or greater than a threshold value.

14. The CDMA network of claim 13, further comprising:
a cell cluster associated with said cell; and
means for computing a cluster performance matrix of said cell cluster when the transcoder loss per frame is equal to or greater than a threshold value.

15. The CDMA network of claim 14, further comprising:
means for conditionally decreasing the pilot power of the cell by a fixed increment when the cell performance matrix is less than the cluster performance matrix.

16. The CDMA network of claim 14, further comprising:
means for conditionally increasing the pilot power of the cell by a fixed increment when the cell performance matrix is equal to or greater than the cluster performance matrix.

17. A computer readable medium storing a computer program for controlling a pilot power of a cell within a CDMA network, said computer readable medium comprising:
computer readable code for determining a transcoder loss per frame within the cell; and
computer readable code for computing a cell performance matrix of the cell when the transcoder loss per frame is equal to or greater than a threshold value.

18. The computer readable medium of claim 17, wherein the cell performance matrix is computed according to:
$$CellPerformanceMetric = ( \frac{CP}{T} ) \times ( \frac{FE}{F} ) \times ( \frac{TLU}{TLD} ) \times ( \frac{Ec}{Io} Average )$$

19. The computer readable medium of claim 17, further comprising:
computer readable code for computing a cluster performance matrix of a cell cluster of the CDMA network that is associated with the cell when the transcoder loss per frame is equal to or greater than a threshold value.

20. The computer readable medium of claim 19, wherein the cluster performance matrix is an average of each cell performance matrix for each cell within the cell cluster, and each cell performance matrix is computed according to:
$$CellPerformanceMetric = ( \frac{CP}{T} ) \times ( \frac{FE}{F} ) \times ( \frac{TLU}{TLD} ) \times ( \frac{Ec}{Io} Average )$$

21. The computer readable medium of claim 19, further comprising:
computer readable code for conditionally decreasing the pilot power of the cell when the cell performance matrix is less than the cluster performance matrix.

22. The computer readable medium of claim 19, further comprising:
computer readable code for conditionally increasing the pilot power of the cell when the cell performance matrix is equal to or greater than the cluster performance matrix.

23. A method for controlling a pilot power of a cell within a CDMA network, said method comprising:
computing a cell performance matrix of the cell;
computing a cluster performance matrix of a cell cluster associated with the cell;
controlling the pilot power based upon a computation of the cell performance matrix and a computation of the cluster performance matrix.

24. A CDMA network, said method comprising:
a cell having a pilot power;
a cell cluster associated with said cell; and
a base station,
wherein said base station is operable to compute a cell performance matrix of said cell,
wherein said base station is further operable to compute a cluster performance matrix of said cell cluster, and
wherein said base station is further operable to control the pilot power based upon a computation of the cell performance matrix and a computation of the cluster performance matrix.

25. A CDMA network, said method comprising:
a cell having a pilot power;
means for computing cell performance matrix of said cell, a cell cluster associated with said cell;
means for computing a cluster performance matrix of said cell cluster; and
means for controlling the pilot power based upon a computation of the cell performance matrix and a computation of the cluster performance matrix.

26. A computer readable medium storing a computer program for controlling a pilot power of a cell within a CDMA network, said computer readable medium comprising:
computer readable code for computing a cell performance matrix of the cell, computer readable code for computing a cluster performance matrix of a cell cluster associated with the cell; and
computer readable code for controlling the pilot power based upon a computation of the cell performance matrix and a computation of the cluster performance matrix.
